(19) United States
(12) Patent Application Publication
(10) Pub. No.: US 2007/0130346 A1
(43) Pub. Date: Jun. 7, 2007

(54) METHOD FOR MAINTAINING TELNET SESSION, TELNET AGENCY AND COMPUTER NETWORK SYSTEM

(76) Inventors: BO Xie, Shanghai (CN); Zhen Gang Li, Shanghai (CN)

Correspondence Address: IBM CORPORATION;INTELLECTUAL PROPERTY LAW, 11400 BURNET ROAD, AUSTIN, TX, 78758, US

(21) Appl. No.: 11/537,185

(22) Filed: Sep. 29, 2006

(30) Foreign Application Priority Data
Dec. 2, 2005 (CN) 200510127413.7

(51) Int. Cl. G06F 15/16

(52) U.S. Cl. 709/227

(57) ABSTRACT

The present invention provides a method, system and computer program product for maintaining a telnet session in a computer network system, comprising: creating sessions with a telnet client and a telnet server respectively by a telnet agency based on a telnet request from the telnet client, and maintaining a telnet session between the telnet client and the telnet server through transmitting data between the sessions. If the telnet client becomes offline during the telnet session, the telnet agency will suspend the telnet session, keep all activities of the telnet session in the telnet agency, and resume the telnet session later according to a request from the telnet client.

### TECHNICAL FIELD

The present invention generally relates to information system technology. Particularly, the present invention relates to technology for maintaining a telnet session in a computer network system. More particularly, the present invention relates to a method, and system for suspending and resuming a telnet session.

### TECHNICAL BACKGROUND

Telnet is known as a protocol for sending/receiving character information to/from a remote server, thereby to use resources of the remote server. Telnet allows a computer on the client's side to remotely login to a server connected via TCP/IP so as to be used as a virtual terminal of the remote server. Thus, in a TCP/IP based network environment, as long as a server opens a telnet port, any authorized client can use the server through the telnet port.

In a telnet session in an UNIX computer system, however, if a user's local system is crashed or the Internet connection is dropped, the user's telnet session will be terminated immediately and cannot be resumed anymore, and all activities in it will be lost, because a conventional UNIX computer system wants a telnet session to end immediately when the session is failed and does not support a telnet client to resume a telnet session.

With the recent developments, there are two kinds of methods for resuming a telnet session:

The first method is as disclosed in U.S. Pat. No. 5,881,239 in a title of “Network System with Resilient Virtual Fault Tolerant Sessions” filed by Tandem. Moreover, now there is a telnet server named as “Georgia SoftWorks Telnet Server” (http://www.georgiasoftworks.com/docs/UTS/UTS userguide.doc), which has the same features as that described in above granted patent. A telnet server can maintain a failed telnet session for a set period of time before completely closing it down. In this method that may resume a telnet session, an enhanced new telnet server must be used to replace the conventional UNIX telnet server. Actually, it is always impossible to apply this method because of security and compatibility reasons.

The second method is to create a “GNU Screen” (http://www.gnu.org/software/screen/), which will not be terminated when a telnet session terminates, as a user's virtual terminal. A telnet client connects a telnet server executes a shell (e.g. Bourne Again Shell), and runs the “GNU Screen” application. Later each running application will be executed “inside” the “GNU Screen”. When a telnet session terminates, the “GNU Screen” survives and each application “inside” the “GNU Screen” also survives. The “GNU Screen” suspends each application running inside it, and the telnet client can resume the applications later. This method must install a “GNU Screen” daemon in the same machine where telnet server is running, and actually it is always impossible to apply this method because of security and compatibility reasons.

### SUMMARY OF THE INVENTION

Thus, in order to solve above problems, the present invention provides a method, system and program product with telnet session resumption function for maintaining a telnet session in a computer network system. When a user experiences a local system crash or a dropped Internet connection, the method and system for maintaining a telnet session according to the present invention will suspend the telnet session, keep all activities in it, and enable the telnet client to resume it later. Compared with the method for maintaining telnet session in existing computer systems, the present invention is transparent to conventional UNIX telnet clients and servers, unnecessary to modify the conventional UNIX telnet clients and servers, and not limited to be deployed on the same machine where the telnet server is running, that is, the invention is not limited to be deployed at the same node in a computer network system where the telnet server is running.

According to an aspect of the invention, there is provided a method for maintaining a telnet session in a computer network system comprising at least a telnet client, at least a telnet server, and a telnet agency, the method comprising:

creating sessions with the telnet client and the telnet server respectively by the telnet agency based on a telnet request from the telnet client, and maintaining a telnet session between the telnet client and the telnet server through transmitting data between the sessions; and

suspending the telnet session, keeping all activities of the telnet session in the telnet agency, and resuming the telnet session later according to a request from the telnet client, by the telnet agency, if the telnet client becomes offline during the telnet session.

Preferably, the method according to the present invention further comprises the following steps:

determining by the telnet agency whether the telnet client requests to create a new session or requests to resume a suspended session;

creating a first session with the telnet client and a second session with the telnet server respectively, by the telnet agency, if it is determined that the telnet client requests to create a new session, and beginning to transmit data between the first session and the second session;

finding out the corresponding suspended session and all kept activities thereof, creating a third session with the telnet client, resuming the suspended session, by the telnet agency, if it is determined that the telnet client requests to resume a suspended session, and beginning to transmit data between the third session and the resumed session.

Preferably, the telnet agency determines whether the telnet client requests to create a new session or requests to resume a suspended session according to a resumption identification in a telnet request from the telnet client.

Preferably, the telnet agency creates the session with the telnet server according to the IP address and the port number of the telnet server inputted by the telnet client.

Preferably, the telnet agency automatically maps a local IP address and port to the IP address and port of the telnet server, thereby creating the session with the telnet server.

Preferably, the telnet agency suspending the telnet session comprises periodically sending NOP (no operation) messages to the telnet server.

Preferably, the telnet agency keeping all activities in the telnet session comprises caching negotiated options and session data related to the telnet session.

Preferably, the telnet agency and the telnet server are located at different nodes of the computer network system respectively.

According to another aspect of the present invention, there is provided a telnet agency for maintaining a telnet session in a computer network system, comprising:

a listen module configured to listen to a telnet request from a telnet client and detect whether the telnet client is offline;

a connection module configured to create connection with a destined telnet server and receive/send data from/to it; and

a control module configured to suspend a telnet session and resume a telnet session.

Preferably, the listen module is further used to verify a resumption identification.

Preferably, the control module comprises:

a map module configured to map a local IP address and port to an IP address and port of a destined telnet server;

a cache module configured to cache all activities in a telnet session; and

a relay module configured to transmit data between a telnet client and a telnet server.

Preferably, the cache module is used to cache options and data negotiated for telnet sessions, re-negotiate telnet options with the telnet server and the telnet client, and transmit the latest cached telnet screen to the telnet client while the telnet client is resuming a suspended telnet session.

According to another aspect of the present invention, there is provided a computer network system, comprising at least a telnet client, at least a telnet server, and above-mentioned telnet agency.

The present invention is transparent to conventional UNIX telnet clients and servers, and can be deployed on another machine instead of the same machine where the telnet server is running, so as to avoid security and compatibility problems.

### BRIEF DESCRIPTION OF THE DRAWINGS

The features of the invention believed to be novel are set forth in the appended claims. The invention itself, however, as well as preferred modes of use, further objectives and advantages thereof, will be best understood with reference to the following detailed description of illustrative embodiments when read in conjunction with the accompanying drawings, wherein:

FIG. 1 is a pictorial representation of a distributed data processing system in which the present invention may be implemented;

FIG. 2 is a pictorial representation of a computer network system with telnet session resuming function according to a preferred embodiment of the present invention;

FIG. 3 is a block diagram of a telnet agency in the computer network system shown in FIG. 2 according to a preferred embodiment of the present invention;

FIG. 4 is a flowchart of a method for maintaining a telnet session in a computer network system according to a preferred embodiment of the present invention;

FIG. 5 shows a telnet process when a telnet client inputs zero as a resumption identification according to a preferred embodiment of the present invention;

FIG. 6 shows a telnet process when a telnet client inputs a valid resumption identification according to a preferred embodiment of the present invention;

FIG. 7 shows a telnet process when the telnet agency automatically performs port mapping and a telnet client inputs zero as a resumption identification according to a preferred embodiment of the present invention;

FIG. 8 is a flowchart of a process for suspending a telnet session according to a preferred embodiment of the present invention; and

FIG. 9 is a flowchart of a process for resuming a suspended telnet session according to a preferred embodiment of the present invention.

### DETAILED DESCRIPTION OF THE INVENTION

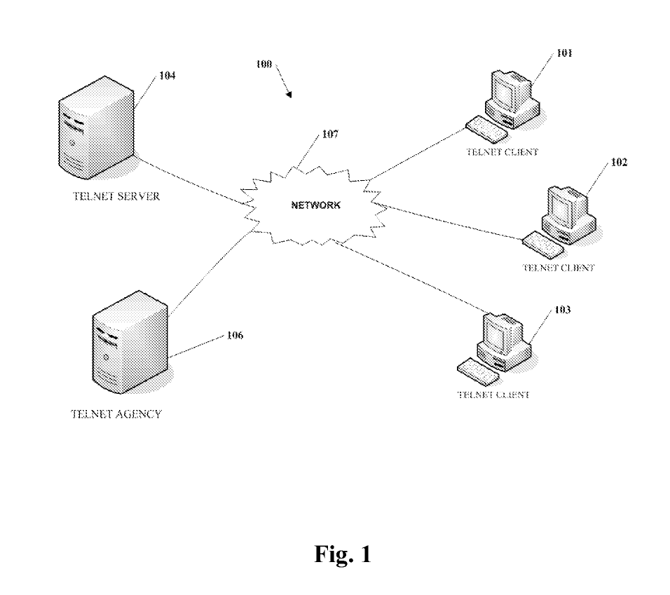

With reference now to the figures, FIG. 1 is a pictorial representation of a distributed data processing system in which the present invention may be implemented. The distributed data processing system 100 comprises a network 107 and various computing devices or computers connected together via the network 107 within the distributed data processing system 100, wherein the network 107 is a medium used to provide communication links between said various devices and computers. The network 107 may comprise permanent connections, such as coaxial cables or optical fibers, or temporary connections through telephone connections.

In the described example, servers 104 and 106 are connected to the network 107. Besides, clients 101, 102, and 103 are also connected to the network 107. These clients 101, 102, and 103 may be, for instance, personal computers or network computers. For the purpose of this application, a network computer may be any computer connected to the network that may receive a program or other application from another computer connected to the network. In the described example, a telnet service program resides on the server 104 and provides telnet services to the server 106. Thus, in the described example, the server 104 is called as a telnet server. The clients 101, 102, and 103 are used as telnet clients of the telnet server 104. The server 106 is used as a telnet agency of the clients 101, 102, and 103 for creating telnet sessions between the clients 101, 102, and 103 and the telnet server 104 based on the requests from the clients 101, 102 and, 103, and keeping all activities of suspended telnet sessions so as to enable telnet clients to resume the suspended sessions later. Thus, in the described example, the server 106 is called as a telnet agency. The distributed data processing system 100 may further comprise other servers, clients, and other devices not shown, and combine the servers 104 and 106 into one that provides both of telnet services and telnet agency services.

In the described example, the distributed data processing system 100 may be a computer system connected via the Internet, wherein the network 107 represents a worldwide collection of networks and gateways that use the TCP/IP suite of protocols to communicate with each other. At the heart of the Internet is a backbone of high-speed data communication lines between the major nodes or host computers, composed of thousands of commercial, government, education and other computer systems that route data and messages. Of course, the distributed data processing system 100 may also be implemented as a number of different types of networks, such as, for example, an intranet, a local area network (LAN) or a wide area network (WAN). FIG. 1 is intended as an example and not as a limitation to the architecture of the present invention.

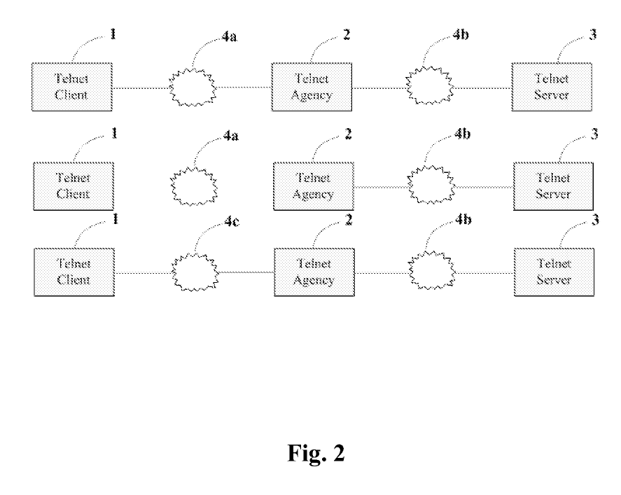

FIG. 2 is an exemplary pictorial representation of a computer network system with telnet session resuming function according to a preferred embodiment of the present invention. First, a telnet client 1 such as telnet client 103 of FIG. 1 connects to a telnet agency 2 such as telnet agency 106 of FIG. 1 to create a session 4a. The telnet agency 2 connects to a telnet server 3 such as telnet server 104 of FIG. 1 to create a session 4b, and the telnet agency 2 transmits data between 4a and 4b, as if the telnet client 1 were connected to the telnet server 3 directly. If there is any client failure or link failure, 4a will terminate, and 4b will be suspended by the telnet agency 2. The telnet client 1 can reconnect to the telnet agency 2 to create a session 4c and the telnet agency 2 transmits data between 4c and 4b as if the telnet client 1 had resumed 4a and 4b.

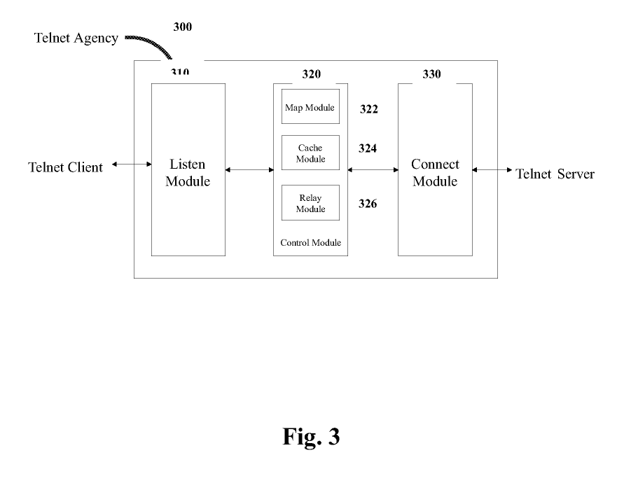

FIG. 3 shows a block diagram of the telnet agency in the computer network system shown in FIG. 2 according to a preferred embodiment of the present invention. The telnet agency 300 comprises three parts: a listen module 310, a control module 320, and a connection module 330.
(1) The listen module 310 is used to listen to a telnet request from a telnet client, detect whether the telnet client is offline, and verify a resumption identification.
(2) The connect module 330 is used to build a connection with a destined telnet server and receive/send data from/to it.
(3) The control module 320 is used to map an IP address and port, suspend a telnet session, and resume a telnet session. The control module 320 is the key module of the telnet agency and comprises three sections: a map module 322, a cache module 324, and a relay module 326.
   i. The map module 322 is used to map a local IP address and port to an IP address and port of a destined telnet server.
   ii. The cache module 324 is used to cache options and data negotiated for telnet sessions, re-negotiate telnet options with the telnet server and the telnet client, and transmit the latest cached telnet screen to the telnet client while the telnet client is resuming a suspended telnet session.
   iii. The relay module 326 is used to transmit data between a telnet client and a telnet server.

From above description it can be seen that, in the present invention, due to applying a telnet agency to cache negotiated option data for a suspended telnet session, it is possible to resume the suspended telnet session later. Besides, the present invention is transparent to conventional UNIX telnet clients and servers, and can be deployed on another machine instead of the same machine where the telnet server is running, so as to avoid security and compatibility problems.

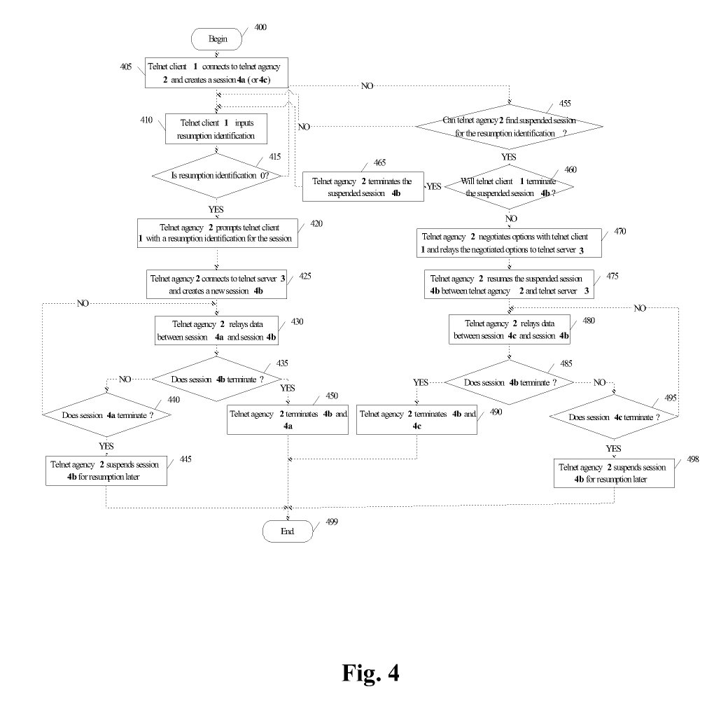

Next, in conjunction with FIG. 4, how to maintain a telnet session through a telnet agency in a network system with telnet session resuming function according to a preferred embodiment of the present invention will be described in detail.

FIG. 4 is a flowchart of a process for maintaining a telnet session according to a preferred embodiment of the present invention, comprising: when a user experiences a local system crash or a dropped Internet connection, the telnet agency will suspend the telnet session, keep all activities in it, and enable the telnet client to resume it later. First, the telnet client 1 connects to the telnet agency 2 to create a session 4a (405). The telnet agency 2 requests the telnet client 1 to input a resumption identification (410). There are two branches:
(1) The resumption identification inputted by the telnet client 1 is zero (“Yes” branch in 415). This means that the telnet client 1 selects to create a new session. Then the telnet agency 2 connects to the telnet server 3 to create a session 4b. The telnet agency 2 transmits data between 4a and 4b, as if the telnet client 1 were connected to the telnet server 3 directly. If there is any client failure or link failure, 4a will terminate, and 4b will be suspended by the telnet agency 2. If 4b terminates, the telnet agency 2 will terminate 4a.
(2) The resumption identification inputted by the telnet client 1 is not zero (“No” branch in 415). If the telnet agency 2 can not find a suspended telnet session corresponding to the resumption identification inputted by the telnet client 1, the telnet agency 2 will request the telnet client 1 to input a resumption identification again. If the telnet agency 2 finds a suspended session 4b corresponding to the resumption identification inputted by the telnet client 1, the telnet agency 2 will ask the telnet client 1 whether it wants to terminate the suspended session 4b. If the telnet client 1 selects to terminate 4b, the telnet agency 2 will terminate 4b; otherwise the telnet agency 2 will negotiate options with the telnet client 1 (the telnet agency 2 has saved the latest negotiated options of the suspended session 4b), and transmit said negotiated options to the telnet server 3. The telnet agency 2 resumes 4b, and transmit data between 4c and 4b, as if the telnet client 1 had resumed 4b. If there is any client failure or link failure, 4c will terminate, and 4b will be suspended by the telnet agency 2. If 4b terminates, the telnet agency 2 will terminate 4c.

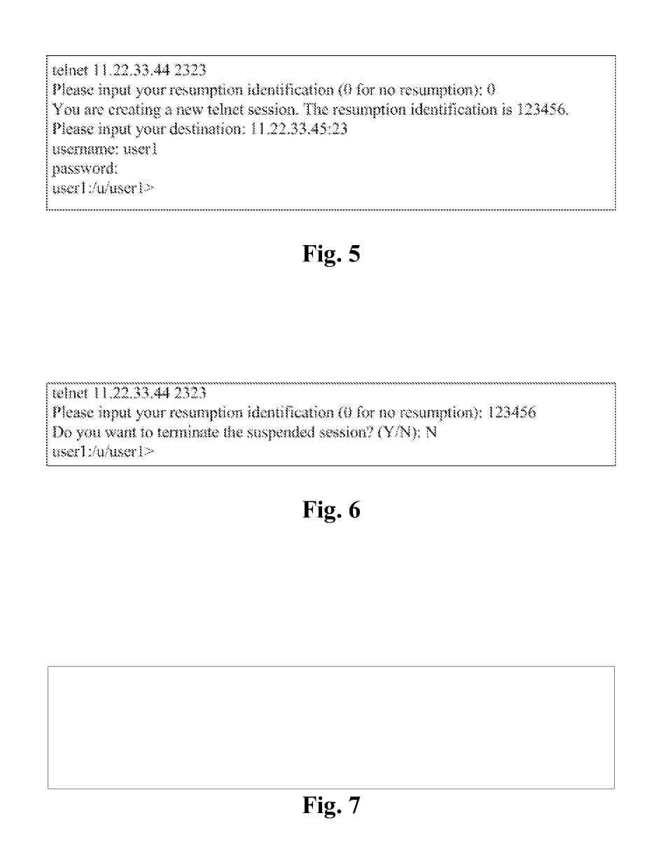

FIG. 5 is a telnet login process when a telnet client inputs zero as a resumption identification according to a preferred embodiment of the present invention. The telnet agency 2 binds the IP address “11.22.33.44” and listens at port “2323”. The following is a detailed description:
(1) The telnet client 1 connects to the telnet agency 2 through a command “telnet 11.22.33.44 2323” and they create a telnet session 4a. The telnet agency 2 sends data to the telnet client 1 through 4a, and needs the telnet client 1 to input a resumption identification, and prompts the telnet client 1 with “Please input your resumption identification (0 for no resumption):”.
(2) The telnet client 1 inputs “0” and sends the data back to the telnet agency 2 through 4a. The telnet agency 2 notifies the telnet client 1 through 4a that the telnet agency 2 is creating a new session and the resumption identification of that session. Furthermore, the telnet agency 2 needs the telnet client 1 to input the IP address and port of the destination telnet server. The telnet agency 2 prompts the telnet client 1 with “You are creating a new telnet session. The resumption identification is 123456” and “Please input your destination:”.
(3) The telnet client 1 inputs “11.22.33.45:23” (11.22.33.45 is the IP address of the telnet server 3, and 23 is the port number of the telnet server 3) and sends the data back to the telnet agency 2 through 4a. The telnet agency 2 connects to the telnet server 3 and they create a telnet session 4b.
(4) From now on, the telnet agency 2 transmits data between 4a and 4b.
(5) The telnet server 3 sends data to the telnet agency 2 through 4b and needs the telnet client 1 to input a username, and the telnet agency 2 transmits the data from 4b to 4a and prompts the telnet client 1 with “username:”.
(6) The telnet client 1 inputs “user1” and sends the data through 4a back to the telnet agency 2, and the telnet agency 2 transmits the data from 4a to 4b, so that the telnet server 3 can receive the username.
(7) The telnet server 3 sends the data through 4b to the telnet agency 2 and needs the telnet client 1 to input a password, and the telnet agency 2 transmits the data from the session 4b to 4a, and prompts the telnet client 1 with “password:”.
(8) The telnet client 1 inputs a password and sends the data through 4a back to the telnet agency 2, and the telnet agency 2 transmits the data from the session 4a to 4b so that the telnet server 3 can receive the password.
(9) If the username and password are correct, the telnet server 3 sends data through 4b to the telnet agency 2 and tells the telnet client 1 that UNIX shell is ready to use. The telnet agency 2 transmits the data from 4b to 4a and prompts the telnet client 1 with “user1:/u/user1>”.

FIG. 6 is a telnet login process when a telnet client inputs a valid resumption identification according to a preferred embodiment of the present invention. The telnet agency binds the IP address “11.22.33.44” and listens at the port “2323”. The following is a detailed description:
(1) The telnet client 1 connects to the telnet agency 2 through a command “telnet 11.22.33.44 2323” and they create a telnet session 4c. The telnet agency 2 sends data to the telnet client 1 through 4c, and needs the telnet client 1 to input a resumption identification, and prompts the telnet client 1 with “Please input your resumption identification (0 for no resumption):”.
(2) The telnet client 1 inputs “123456” and sends the data back to the telnet agency 2 through 4c, and the telnet agency 2 finds the suspended telnet session 4b for the resumption identification “123456”.
(3) The telnet agency 2 sends the data to the telnet client 1 through 4c and needs the telnet client 1 to select to terminate or resume the suspended session 4b, and prompts the telnet client 1 with “Do you want to terminate the suspended session? (Y/N):”. The telnet client 1 inputs “N” and sends the data through 4c back to the telnet agency 2.
(4) The telnet agency 2 negotiates options with the telnet client 1 through 4c and relays the negotiated options to the telnet server 3 through 4b.
(5) The telnet agency 2 sends the last cached data of 4b to the telnet client 1 through 4c and prompts the telnet client 1 with “user1:/u/user1>”.
(6) From now on, the telnet agency 2 transmits data between 4c and 4b.

It should be noticed that, in above process, the telnet agency creates a session with the telnet server based on the telnet server's IP address and port inputted by the telnet client. Besides, in order to make the present invention be transparent to conventional UNIX telnet clients and servers, in the case that the telnet agency s includes a map module, it is possible to use the map module to map the local IP address and port number inputted by the telnet client to the IP address and port number of the telnet server, thereby creating a session with the telnet server.

FIG. 7 is a telnet login process when a telnet agency (specifically, a map module) performers port mapping and a telnet client inputs zero as a resumption identification according to a preferred embodiment of the present invention. For example, a telnet agency maps its local IP address and port 11.22.33.44:2323 to a destined telnet server's IP address and port 11.22.33.45:23. Then there is no prompt “Please input your destination:” as illustrated in FIG. 5. All steps are the same as that illustrated in FIG. 5 except that there is no need for a user to input a destined telnet server's IP address and port, because the telnet agency has mapped its local IP address and port 11.22.33.44:2323 to a destined telnet server's IP address and port 11.22.33.45:23.

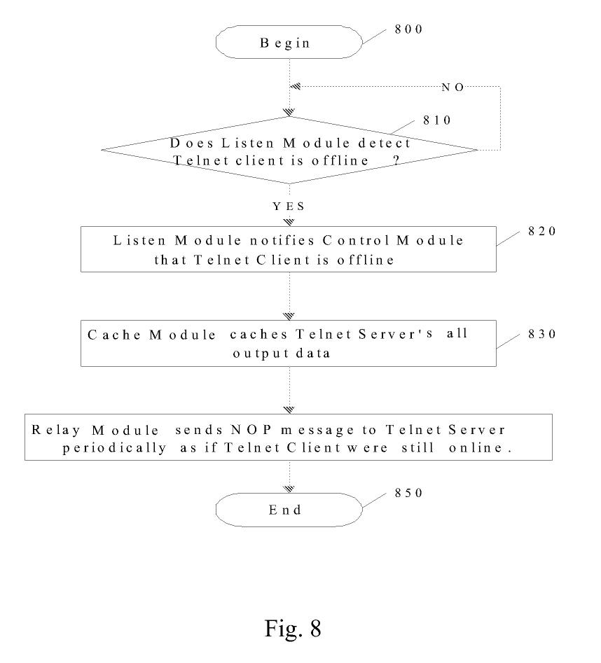

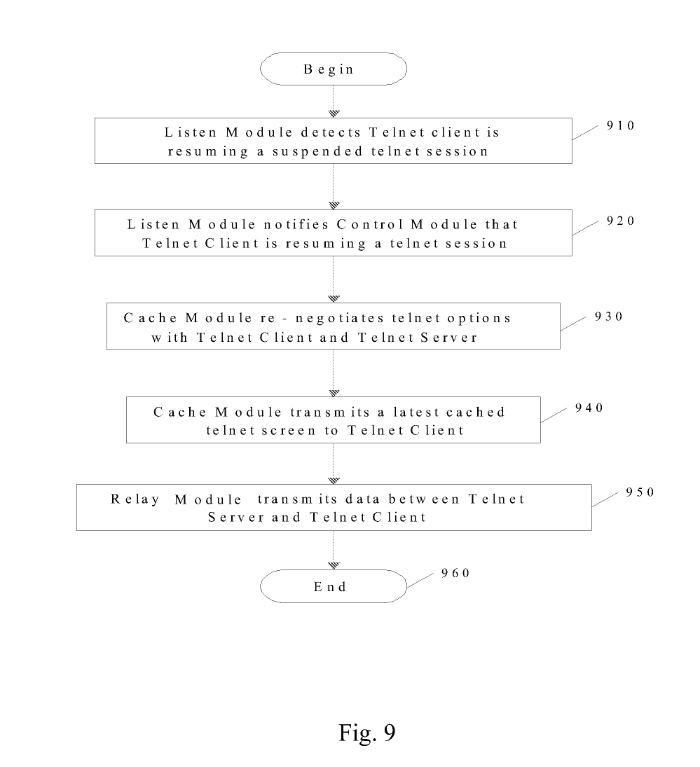

Next, in conjunction with FIGS. 8 and 9, the suspension process and resumption process of a telnet session in a telnet agency will be further described.

FIG. 8 is a flowchart of the process for suspending a telnet session according to a preferred embodiment of the present invention. If the listen module detects that a telnet client is offline (Step 810), it will notify the control module that the telnet client is offline (Step 820). The cache module of the control module will cache all output data of the telnet server, including negotiated options and other telnet data (Step 830). At the same time, the relay module of the control module will start sending NOP (no operation) messages to the telnet server periodically (Step 840), as if the telnet client were still online.

FIG. 9 is a flowchart of the process for resuming a suspended telnet session according to a preferred embodiment of the present invention. If the listen module detects that a telnet client is attempting to resume a suspended telnet session (Step 910), it will verify the telnet client's resumption identification. If the resumption identification is correct, it will notify the control module that a telnet client is resuming a suspended telnet session (Step 920). The cache module of the control module will re-negotiate telnet options with the telnet client and the telnet server (Step 930) to make sure that the reconnected telnet client and telnet server can understand each other and exchange data correctly. The cache module of the control module will transmit the latest cached telnet screen to the reconnected telnet client (Step 940). Then the relay module will transmit data between the telnet server and the telnet client (Step 950), and the telnet client resumes the suspended session successfully.

The invention can take the form of an entirely hardware embodiment, an entirely software embodiment or an embodiment containing both hardware and software elements. In a preferred embodiments the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of s network adapters.

The description of the present invention has been presented for purposes of illustration and description but is not intended to exhaust or limit the invention in the form disclosed. Many modifications and variations will be apparent to those of ordinary skill in the art. The embodiments were chosen and described in order to best explain the principles of the invention and the practical application, and to enable others of ordinary skill in the art to understand the invention for various embodiments with various modifications as are suited to the particular use contemplated.

1. A method of maintaining a telnet session in a computer network system, wherein said computer network system comprises at least a telnet client, at least a telnet server, and a telnet agency, the method comprising:
creating sessions with the telnet client and the telnet server respectively by the telnet agency based on a telnet request from the telnet client, and maintaining a telnet session between the telnet client and the telnet server through transmitting data between the sessions; and
suspending the telnet session, keeping all activities of the telnet session in the telnet agency, and resuming the telnet session later according to a request from the telnet client, by the telnet agency, if the telnet client becomes offline during the telnet session.

2. The method according to claim 1, further comprising:
determining by the telnet agency whether the telnet client requests to create a new session or requests to resume a suspended session;
creating a first session with the telnet client and a second session with the telnet server respectively, by the telnet agency, if it is determined that the telnet client requests to create a new session, and beginning to transmit data between the first session and the second session; and
finding out the corresponding suspended session and all kept activities thereof, creating a third session with the telnet client, resuming the suspended session, by the telnet agency, if it is determined that the telnet client requests to resume a suspended session, and beginning to transmit data between the third session and the resumed session.

3. The method according to claim 2, wherein the telnet agency determines whether the telnet client requests to create a new session or requests to resume a suspended session according to a resumption identification in the telnet request from the telnet client.

4. The method according to claim 1, wherein the telnet agency creates the session with the telnet server according to an IP address and port number of the telnet server inputted by the telnet client.

5. The method according to claim 1, wherein creating the session with the telnet server further comprises the telnet agency automatically mapping a local IP address and port to the telnet server IP address and port.

6. The method according to claim 1, wherein the telnet agency suspending the telnet session comprises sending NOP (no operation) messages to the telnet server periodically.

7. The method according to claim 1, wherein the telnet agency keeping all activities in the telnet session comprises caching negotiated options and session data related to the telnet session.

8. The method according to claim 1, wherein the telnet agency and the telnet server are located at different nodes of the computer network system.

9. A telnet agency for maintaining a telnet session in a computer network system, comprising:
a listen module configured to listen to a telnet request from a telnet client and detect whether the telnet client is offline;
a connection module configured to create a connection with a destined telnet server and receive/send data from/to it; and
a control module configured to suspend a telnet session and resume the telnet session.

10. The telnet agency according to claim 9, wherein the listen module is further used to verify a resumption identification.

11. The telnet agency according to claim 9, wherein the control module comprises:
a map module configured to map a local IP address and port to the IP address and port of a destined telnet server;
a cache module configured to cache all activities in a telnet session; and
a relay module configured to transmit data between a telnet client and a telnet server.

12. The telnet agency according to claim 11, wherein the cache module is used to cache options and data negotiated for telnet sessions, re-negotiate telnet options with the telnet server and the telnet client, and transmit a latest cached telnet screen to the telnet client while the telnet client is resuming a suspended telnet session.

13. A computer system for maintaining a telnet session in a computer network, wherein said computer system comprises at least a telnet client, at least a telnet server, and a telnet agency, said computer system comprises:
means for creating sessions with the telnet client and the telnet server respectively by the telnet agency based on a telnet request from the telnet client, and for maintaining a telnet session between the telnet client and the telnet server through transmitting data between the sessions; and
means for suspending the telnet session, keeping all activities of the telnet session in the telnet agency, and for resuming the telnet session later according to a request from the telnet client, by the telnet agency, if the telnet client becomes offline during the telnet session.

14. The computer system according to claim 13, said system further comprising:
means for determining by the telnet agency whether the telnet client requests to create a new session or requests to resume a suspended session;
means for creating a first session with the telnet client and a second session with the telnet server respectively, by the telnet agency, if it is determined that the telnet client requests to create a new session, and for beginning to transmit data between the first session and the second session; and
means for finding out the corresponding suspended session and all kept activities thereof, for creating a third session with the telnet client, and for resuming the suspended session, by the telnet agency, if it is determined that the telnet client requests to resume a suspended session, and means for beginning to transmit data between the third session and the resumed session.

15. The computer system according to claim 14, wherein the telnet agency determines whether the telnet client requests to create a new session or requests to resume a suspended session according to a resumption identification in the telnet request from the telnet client.

16. The computer system according to claim 13, wherein the telnet agency creates the session with the telnet server according to an IP address and port number of the telnet server inputted by the telnet client.

17. The computer system according to claim 13, wherein the means for creating the session with the telnet server further comprises means for the telnet agency to automatically map a local IP address and port to the telnet server IP address and port.

18. The computer system according to claim 13, wherein the means for the telnet agency suspending the telnet session comprises means for sending NOP (no operation) messages to the telnet server periodically.

19. A computer program product comprising a recordable computer usable medium having computer usable program code for maintaining a telnet session in a computer network, wherein said computer network system comprises at least a telnet client, at least a telnet server, and a telnet agency, said computer program product comprising:
computer usable program code for creating sessions with the telnet client and the telnet server respectively by the telnet agency based on a telnet request from the telnet client, and maintaining a telnet session between the telnet client and the telnet server through transmitting data between the sessions; and
computer usable program code for suspending the telnet session, keeping all activities of the telnet session in the telnet agency, and resuming the telnet session later according to a request from the telnet client, by the telnet agency, if the telnet client becomes offline during the telnet session.

20. The computer program product according to claim 19, further comprising:
computer usable program code for determining by the telnet agency whether the telnet client requests to create a new session or requests to resume a suspended session;
computer usable program code for creating a first session with the telnet client and a second session with the telnet server respectively, by the telnet agency, if it is determined that the telnet client requests to create a new session, and beginning to transmit data between the first session and the second session; and
computer usable program code for finding out the corresponding suspended session and all kept activities thereof, creating a third session with the telnet client, resuming the suspended session, by the telnet agency, if it is determined that the telnet client requests to resume a suspended session, and beginning to transmit data between the third session and the resumed session.
